(19) United States
(12) Patent Application Publication
(10) Pub. No.: US 2005/0205287 A1
(43) Pub. Date: Sep. 22, 2005

(54) Electrical conductor cable and method for forming the same

(76) Inventors: Raymond Browning, San Carlos, CA (US); Terry S. McQuarrie, San Jose, CA (US)

Correspondence Address: CHRISTIE, PARKER & HALE, LLP, PO BOX 7068, PASADENA, CA, 91109-7068, US

(21) Appl. No.: 11/084,598

(22) Filed: Mar. 17, 2005

Related U.S. Application Data
(60) Provisional application No. 60/554,287, filed on Mar. 17, 2004.

(51) Int. Cl. H01B 9/02

(52) U.S. Cl. 174/102 R; 174/113 C

(57) ABSTRACT

An electrical conductor cable for long distance transmission of electrical current is provided. The conductor cable includes a plurality of individual cylindrically shaped non-conductive components. The conductor cable further includes an electrically conductive member located on an exterior of the core. A method for forming such a conductor cable is also provided.

### CROSS-REFERENCE TO RELATED APPLICATION(S)

This is an ordinary application which is based upon and claims priority to U.S. Provisional Application No. 60/554,287, filed Mar. 17, 2004, the contents of which are fully incorporated herein by reference.

### BACKGROUND OF THE INVENTION

The present invention is related to the field of electrical conductor cables designed to transmit electrical power between supporting poles or towers, and more specifically to electrical conductor cables and to methods of forming the same.

The prior art teaches electrical transmission conductors formed of a steel component or supporting member designed to carry the entire cable which includes an electrical conductor such as aluminum or copper conductor. Usually, the conductor is enclosed within an outer sheath of the steel supporting member.

In recent years, there has been an increased interest in electrical cables in which there is a reinforced plastic composite component capable of bearing a substantial portion of the load, if not all of the load, of the cable when spanned between a pair of uprights at substantial distances from one another.

One known apparatus is set forth in U.S. patent application Ser. No. 10/037,814, filed Dec. 28, 2001, in which one or more electrical conductors surrounds a load-carrying core comprised of reinforced plastic composite components. The core comprises individual trapezoidally-shaped pieces which are abutted together in such manner as to form a cylindrical core. This type of structure is necessary in order to allow for the internal carrying of a fiber optic cable or other message carrying cable. However, in many cases, no message carrying cable is used and, hence, there is no need for the complex construction involving trapezoidally shaped core components.

Other efforts have been focused on limiting “sag” in the cable, which occurs as a result of the heat generated by the transmission of electricity as well as the load placed on the cable over time by its own weight. Thermoplastics and fiberglass have both been used to support conductor cables, but both materials exhibit a tendency to sag over time.

A conductor cable must also be able to withstand the internal forces that result from wrapping the cable onto a spool or a drum for storage and/or transport. However, core components exhibiting sufficient rigidity to bear the load of the cable also make it difficult for the wrapping to occur.

Conductor cables are subject to oscillations resulting from vibrations caused by wind which in turn result in metal fatigue to the metal portions of the cable.

Therefore, a need exists for a cable support structure which can effectively support the load of the cable and which can be produced inexpensively and effectively. There exists a further need for a cable which can be effectively wrapped about a spool and which, when hung, can dampen the effects of vibrations caused by wind.

### SUMMARY OF THE INVENTION

The current invention specifically addresses the prior art deficiencies. More particularly, the current invention teaches a electrical conductor cable wherein a central support core comprises a plurality of individual cylindrically shaped core components which are non-conductive, and a conductive member is located on an outer surface of the core, and a method of forming the same.

In one exemplary embodiment, the core components constitute reinforced plastic composite material such as a fiberglass epoxy resin combination. Each of the core components can be effectively pultruded, that is they are pulled through an extrusion type apparatus in which the resin is heated and allowed to impregnate the fibers and cure. Other forms of reinforced plastic composite materials, including other fibrous materials and other resins, can also be used. It is also possible to use a mixture of individual cores with certain of the cores having different properties than others. As an example, a carbon composite core can be mixed with multiple glass composite cores. A carbon fiber core has low creep and high tensile strength, while the glass fiber core is cheaper and sags less.

The central core can also constitute core components comprising fibrous strands impregnated with a curable resin matrix having a high matrix softening temperature. Such core components can be formed with ultraviolet hardening techniques, wherein material is pushed through an extrusion-type die and then cured by ultraviolet light. The ultraviolet light causes the resin to cure relatively rapidly, such that speeds of more than one hundred feet per minute can be employed, whereas pultrusion is limited to much lower speeds. Pultrusion, however, can employ multiple dies wherein, for example, 8-10 core components can be extruded simultaneously. The ultraviolet curing process is usually performed on one core component at a time due to the high speed involved. Either process provides for reduced cost, as the cylindrical core components are easier to pultrude than other more complicated shapes and many core components can be pultruded simultaneously, while the ultraviolet curing method employs high speeds not otherwise obtainable.

The core components can be formed individually and wound together or otherwise disposed together in a generally cylindrically shaped core. The multiple core components can be twisted around a central individual core component by a geometrically stable process allowing for high speed filament winding. The core components are enveloped in a sheath, and placement of the core components in the sheath can occur simultaneously as the core components are being disposed together. The sheath serves to protect the core components from water, and can comprise molded fiberglass or fiberglass tape. In an alternative embodiment, no sheath is included in the cable.

The multi-component core is effective in reducing the manufacturing costs and, particularly, the winding costs. The symmetry of the individual core components allows the total central core to be formed with a twist so that it is geometrically stable and requires a simple winding machine operable at high speeds.

The core components, in accordance with the invention, can be either twisted or they can remain untwisted. In some cases, twisting the components permits greater winding capability on a drum or similar device. However, the general use of the cylindrically shaped core components allows the core in the invention to be easily and readily wound on a spool and unwound from that spool without degrading the cable.

Not only is the use of a cylindrically shaped core formed of a plurality of core components more efficient and less costly to produce, but the finished cable is much easier to splice. With individual core components, splicing without having to deal with complex shapes, such as trapezoidally shaped core components, simplifies the splicing process.

The smaller pultruded components provided in this invention are far more flexible than those in the prior art constructions, which further aid in ease of winding the cable on a spool or drum. Thus, the multi-core cable is more flexible and the splicing is more reliable.

The electrically conductive component of the cable may be a cylindrically shaped electrical conductor which surrounds and encloses the core and sheath. The conductor can be placed over the core and sheath by a high speed filament winding process as known in the art. In this process, the conductive material is wound helically in one direction along the length of the core. A second helical winding of the conductive material can also be performed along the length of the core, preferably in a direction opposite that of the first winding.

In an exemplary embodiment, the electrically conductive component includes a plurality of individually generally cylindrically shaped elongate conductive elements which, taken together, surround the core and sheath thus formed. In an alternative embodiment, the conductive material is formed by trapezoidal wire which, when wound helically along the length of the core, creates a substantially sheath-like outer conductive surface. In these embodiments of the invention, the core constitutes the reinforced plastic composite component, although it should be understood that the reinforced composite component could extend around an electrically conductive core.

One of the significant advantages of the present invention, where a plurality of cylindrical core components are used to form the central core of the cable, is that the core components are formed much less expensively than with trapezoidally shaped components. In this way, a simple standard pultrusion arrangement can be used. With trapezoidally shaped components, it is necessary to use special dies and the like. Further, the throughput rate is increased substantially using cylindrically shaped core components.

Another significant advantage of the present invention is the fact that the conductor cable can be used in precisely those locations where conventional cables are presently used and they can be mounted in precisely the same manner. Thus, the substitution of the cable of the present invention can be accomplished easily, at low cost and, more importantly, with existing cable laying equipment.

Yet another significant advantage of the multiple component core is the damping effect of the components. The friction between surfaces of the individual core components has a damping force on the vibrations caused by the wind.

Yet another significant advantage of the present invention is that the materials used to comprise the core of the electrical conductor cable have a coefficient of thermal expansion that is about half that of steel. This lower coefficient of thermal expansion in the core combines with that of the conductive material, and by the law of mixtures provides a cable that expands less (and therefore, sags less) than conventional conductor cables employing steel or any other material having a greater coefficient of thermal expansion than the materials used in the present invention.

This present invention thereby provides a unique and novel electrical conductor cable, which thereby fulfills all of the above-identified objects and other objects which will become more fully apparent from the consideration of the forms in which it may be embodied.

In an exemplary embodiment, an electrical conductor cable for long distance transmission of electrical current is provided. The cable includes a plurality of individual cylindrically shaped non-conductive components. The components together constitute a generally cylindrically shaped core. An electrically conductive member located on an exterior surface of the cylindrically shaped core is also provided. The electrically conductive member provides transmission of electrical current, and the core bears substantially the entire load imposed by the cable.

In a further exemplary embodiment, the core components include carbon composite material. In another exemplary embodiment, the core components comprise glass composite material. In a yet further exemplary embodiment, the core components comprise reinforced plastic material. In a yet further exemplary embodiment, the core components comprise any combination of carbon composite material, glass composite material, and reinforced plastic material.

In a further exemplary embodiment, the core components are cured using ultraviolet light. In a yet further exemplary embodiment, the core components are twisted about a central core component. In a still yet further exemplary embodiment, the conductor cable is wrapped around a spool.

In a further exemplary embodiment, a cylindrically shaped sheath surrounds the central core. In a yet further embodiment, six core components are helically wound about a central core component.

In another exemplary embodiment, a method for forming an electrical conductor cable is provided. The method includes impregnating a core component material with resin. The method also includes pultruding the impregnated core component material to form a plurality of core components, arranging the core components to form a core, forming an outer conductive surface, and placing the outer conductive surface around the core components, the combination of core components and outer conductive surface forming the electrical conductor cable.

In a further exemplary embodiment, the core components each have a cylindrical shape. In a yet further exemplary embodiment, after pultruding, the core components are arranged to form a generally cylindrical core. In a still yet further exemplary embodiment, the core components include a material selected from a group consisting of carbon composite material, glass composite material, and reinforced plastic material.

In a further exemplary embodiment, arranging includes helically winding the core components about a length of a central core component. In a yet further exemplary embodiment, the method further requires wrapping the electrical conductor cable around a spool. In a still yet further exemplary embodiment, forming the outer conductive surface includes helically wrapping conductive members about a length of the core.

In another exemplary embodiment, a method is provided for forming an electrical conductor cable. The method includes impregnating a core component material with a curable resin, drawing the core component material through a die forming core components, curing the resin with ultraviolet light, arranging the core components to form a core, forming an outer conductive surface, and surrounding the core components with the outer conductive surface, wherein the combination of core components and outer conductive surface forms the electrical conductor cable.

In a further exemplary embodiment, the core components have a cylindrical shape. In a yet further exemplary embodiment, the core components comprise material selected from a group consisting of carbon composite material, glass composite material, and reinforced plastic material.

In a further exemplary embodiment, arranging includes helically winding the core components about a length of a central core component.

In a further exemplary embodiment, the method further requires wrapping the electrical conductor cable around a spool. In a yet further exemplary embodiment, forming the outer conductive surface requires helically wrapping conductive members around a length of the core.

The invention is more fully illustrated in the accompanying drawings and described in the following detailed description of the invention. However, it should be understood that the accompanying drawings and the detailed description are set forth only for purposes of illustrating the general principles of the invention.

### BRIEF DESCRIPTION OF THE DRAWINGS

Having thus described the invention in general terms, reference will now be made to the accompanying drawings in which:

FIG. 1 is an end view of an exemplary embodiment of the present invention;

FIG. 2 is a perspective view of the exemplary embodiment of FIG. 1;

### DETAILED DESCRIPTION OF THE INVENTION

The current invention teaches a electrical conductor cable wherein a central support core comprises a plurality of individual cylindrically shaped core components which are non-conductive, and a conductive member is located on an outer surface of the core, and a method of forming the same.

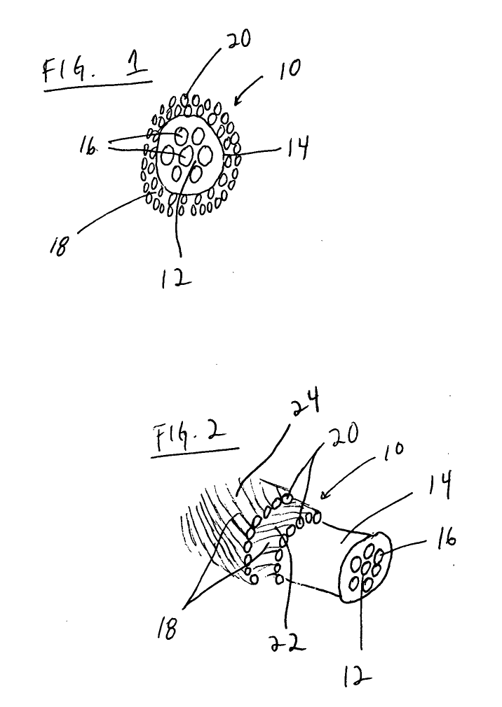

FIG. 1 shows an end view of an embodiment of the present invention. A electrical conductor cable 10 is shown. The electrical conductor cable 10 includes a core 12 having an outer sheath 14 and core components 16. The cable 10 further includes a conductive outer surface 18 which is placed on the outer sheath 14 of the core 12.

The core components 16 of the core 12 can be formed by reinforced plastic composites, carbon fiber composites, or glass composites, or any combination thereof. The materials used to form the core components 16 may be impregnated with resin and cured by any known method, including curing during a pultrusion process or by ultraviolet light. The core components may further be coated with a corrosion resistant glass layer before impregnated with resin, thus ensuring that any cracks in the cured resin matrix do not negatively affect the cable's ability to resist corrosion. As corrosive resistant glass is more expensive than ordinary glass, using the corrosive resistant glass only as a coating, rather than to form the core component 16, reduces the costs of manufacture.

The core components 16 of the present invention may be formed by a pultrusion process. The core components 16 may be pultruded individually or simultaneously from a core component material impregnated with resin. Each individual core component may be placed on a spool. The resin is cured by heating by a heated die during the pultrsion process. Alternatively, the core components 16 may be formed by drawing a core component material impregnated with resin through a die. The drawn core components are then cured using ultraviolet light. The core component materials in an exemplary embodiment may include reinforced plastic composites, carbon composite, or glass composites, or any combination thereof. In an exemplary embodiment, the resin is a thermoset resin. In an exemplary embodiment, the core components are shaped substantially cylindrically as shown in FIG. 1. This can be accomplished by either of the aforementioned processes.

The core components 16 can then be wound together or otherwise disposed together in a generally cylindrically shaped core 12 by a winding machine. In an exemplary embodiment, a central core component serves as central point, about which six other core components 16 are wound helically. The winding of the individual core components can be sharp or lazy, but in an exemplary embodiment constitutes one revolution around a circumference of the central core component per 3 feet of length of the central core component.

The outer sheath 14 of the core 12 can be made of molded fiberglass, or fiberglass tape, or made from another material that serves to protect the core components from water or other outside corrosive materials. In an alternative embodiment, the outer sheath 14 is not present.

The conductive outer surface 18 of the cable 10 is shown in FIGS. 1 and 2. FIG. 2 shows the electrical conductor cable 10 having different layers staggered for clarity. The conductive outer surface 18 may include any known conductive material, such as copper or aluminum, which can be extruded or otherwise formed in any conventional metal forming operation. The conductive outer surface material 18 is placed over the core 12 and outer sheath 14 by a winding machine, such as a high speed filament winding machine. The conductive outer surface of the cable includes one or more layers of electrically conductive members 20. In an exemplary embodiment, the conductive members 20 include ⅛-inch cylindrical wires. A first set of the wires are helically wrapped along the length of the core 12 in one direction defining a first layer 22, and a second set of wire are helically wrapped in the opposite direction defining a second layer 24. Alternatively, trapezoidal wires are used to form the layers, thus creating a substantially sheath-like outer conductive surface.

In an exemplary embodiment, the conductor cable is approximately 1 inch in diameter, while the core is somewhere in the range of about ⅓ to about ½ inch. The individual core components are about ⅙ inch to about ⅛ inch in diameter, but may vary depending on the number of core components used. In this exemplary embodiment, the cable of the present invention is able to support its own weight when hung from power lines and the like, in addition to having sufficient capacity for transmission of electricity to operate in current systems.

In another exemplary embodiment, the core components 16 can be woven and/or twisted together. In another exemplary embodiment, the conductor cable includes a protective and/or insulating sheath around the conductive outer surface 18.

Upon being formed, the conductor cable 10 can be wound about a spool or drum for transport or storage. The geometry and materials used to form the cable allow winding and unwinding from the spool or drum without causing damage to the structure of the cable.

While the invention has been described by way of exemplary embodiments, it is to be understood that the words which have been used are words of description and not of limitation. Therefore, changes may be made within the scope of the appended claims without departing from the true scope and spirit of the invention.

1. An electrical conductor cable for long distance transmission of electrical current comprising:
a plurality of individual cylindrically shaped non-conductive components, wherein the components together constitute a generally cylindrically shaped central core; and
an electrically conductive member located on an exterior surface of the cylindrically shaped core, wherein the electrically conductive member provides transmission of electrical current, wherein the core bears substantially the entire load imposed by the cable.

2. An electrical conductor cable according to claim 1 wherein the core components comprise carbon composite material.

3. An electrical conductor cable according to claim 1 wherein the core components comprise glass composite material.

4. An electrical conductor cable according to claim 1 wherein the core components comprise reinforced plastic material.

5. An electrical conductor cable according to claim 1 wherein the core components are comprised of material selected from a group consisting of carbon composite material, glass composite material, and reinforced plastic material.

6. An electrical conductor cable according to claim 1 wherein each of the core components is surrounded by a corrosive resistant layer.

7. An electrical conductor cable according to claim 1 wherein the core components are cured using ultraviolet light.

8. An electrical conductor cable according to claim 1 wherein the core components are twisted about a central core component.

9. An electrical conductor cable according to claim 1 wherein the conductor cable is wrapped around a spool.

10. An electrical conductor cable according to claim 1 wherein a cylindrically shaped sheath surrounds the central core.

11. An electrical conductor cable according to claim 1 wherein only six core components are helically wound about a central core component.

12. A method of forming an electrical conductor cable comprising:
impregnating a core component material with a resin;
pultruding the impregnated core component material to form a plurality of core components;
arranging the core components to form a core;
forming an outer conductive surface; and
placing the outer conductive surface around the core components, the combination of core components and outer conductive surface forming the electrical conductor cable.

13. A method according to claim 12 wherein the core components have a cylindrical shape.

14. A method according to claim 12 wherein after pultruding, the core components are arranged to form a generally cylindrical core.

15. A method according to claim 12 wherein the core components comprise material selected from a group consisting of carbon composite material, glass composite material, and reinforced plastic material.

16. A method according to claim 12 wherein arranging comprises helically winding the core components around a length of a central core component.

17. A method according to claim 12 further comprising wrapping the electrical conductor cable around a spool.

18. A method according to claim 12 wherein forming the outer conductive surface comprises helically wrapping conductive members around a length of the core.

19. A method of forming an electrical conductor cable comprising the steps:
impregnating a core component material with a resin;
drawing the core component material through a die forming core components;
curing the resin with ultraviolet light;
arranging the core components to form a core;
forming an outer conductive surface; and
surrounding the core with the outer conductive surface, wherein the combination of core components and outer conductive surface forms the electrical conductor cable.

20. A method according to claim 19 wherein the core components have a cylindrical shape.

21. A method according to claim 19 wherein the core components comprise material selected from a group consisting of carbon composite material, glass composite material, and reinforced plastic material.

22. A method according to claim 19 wherein arranging comprises helically winding the core components about a length of a central core component.

23. A method according to claim 19 and further comprising wrapping the electrical conductor cable around a spool.

24. A method according to claim 19 wherein forming the outer conductive surface comprises helically wrapping conductive members around a length of the core.
